(19) United States
(12) Patent Application Publication
(10) Pub. No.: US 2011/0023854 A1
(43) Pub. Date: Feb. 3, 2011

(54) PISTON ARRANGEMENT FOR A TWO-STROKE LOCOMOTIVE DIESEL ENGINE HAVING AN EGR SYSTEM

(76) Inventors: James W. Heilenbach, Riverside, IL (US); Frank M. Graczyk, Darien, IL (US); Kenneth M. Sinko, Oak Park, IL (US)

Correspondence Address: LAW OFFICES OF EUGENE M. CUMMINGS, P.C., ONE NORTH WACKER DRIVE, SUITE 4130, CHICAGO, IL, 60606, US

(21) Appl. No.: 12/848,511

(22) Filed: Aug. 2, 2010

Related U.S. Application Data
(60) Provisional application No. 61/230,698, filed on Aug. 1, 2009.

(51) Int. Cl. F02B 23/00

(52) U.S. Cl. 123/661

(57) ABSTRACT

The present invention is directed to a piston arrangement with a unique bowl geometry for optimizing a two-stroke locomotive diesel engine having an exhaust gas recirculation (“EGR”) system. This piston arrangement achieves a reduced level of smoke and particulate matter; promotes the mixing process in the engine cylinder; and provides a lower compression ratio for reducing NOₓ emissions.

### CROSS-REFERENCE TO RELATED APPLICATIONS

This application is a Nonprovisional Patent Application, which claims benefit to U.S. Provisional Application Ser. No. 61/230,698, entitled “Exhaust Gas Recirculation System for a Locomotive Two-Stroke Uniflow Scavenged Diesel Engine,” filed Aug. 1, 2009, the complete disclosure thereof being incorporated herein by reference.

### TECHNICAL FIELD

This invention relates to a locomotive diesel engine and, more particularly, to a piston arrangement with a unique bowl geometry for a two-stroke locomotive diesel engine having an exhaust gas recirculation system.

### BACKGROUND OF THE INVENTION

The present invention generally relates to a locomotive diesel engine and, more particularly, to a piston arrangement with a unique bowl geometry for optimizing a two-stroke locomotive diesel engine having an exhaust gas recirculation (“EGR”) system. This piston arrangement achieves a reduced level of smoke and particulate matter; promotes the mixing process in the engine cylinder; and provides a lower compression ratio for reducing NOₓ emissions.

FIG. 1 illustrates a locomotive 100 including a uniflow two-stroke diesel engine system 200. As shown in FIGS. 2 and 3, the locomotive diesel engine system 200 generally includes an air system having a turbocharger 300 having a compressor 302 and a turbine 304 which provides compressed air to an engine 306 having an airbox 308, power assemblies 310, an exhaust manifold 312, and a crankcase 314. In a typical locomotive diesel engine system 200, the turbocharger 300 increases the power density of the engine 306 by compressing and increasing the amount of air transferred to the engine 306.

More specifically, the turbocharger 300 draws air from the atmosphere 316, which is filtered using a conventional air filter 318. The filtered air is compressed by a compressor 302. The compressor 302 is powered by a turbine 304, as will be discussed in further detail below. A larger portion of the compressed air (or charge air) is transferred to an aftercooler 320 (or otherwise referred to as a heat exchanger, charge air cooler, or intercooler) where the charge air is cooled to a select temperature. Another smaller portion of the charge air is transferred to a crankcase ventilation oil separator 322 which evacuates the crankcase 314; entrains crankcase gas; and filters entrained crankcase oil before releasing the mixture of crankcase gas and compressed air into the atmosphere 316.

The cooled charge air from the aftercooler 320 enters the engine 306 via an airbox 308. The decrease in charge air intake temperature provides a denser intake charge to the engine which reduces NOₓ emissions while improving fuel economy. The airbox 308 is a single enclosure which distributes the cooled charge air via intake ports to a plurality of cylinders (e.g., 324). Each of the cylinders (e.g., 324) are closed by cylinder heads (e.g., 326). Fuel injectors (not shown) in the cylinder heads (e.g., 326) introduce fuel into each of the cylinders (e.g., 324), where the fuel is mixed and combusted with the cooled charge air. Each cylinder (e.g., 324) includes a piston (e.g., 328) which transfers the resultant force from combustion to the crankshaft 330 via a connecting rod (e.g., 332). The piston (e.g., 328) includes a piston bowl, which facilitates mixture of fuel and trapped gas (including cooled charge air) necessary for combustion. The cylinder heads (e.g., 326) include exhaust ports controlled by exhaust valves (e.g., 334) mounted in the cylinder heads (e.g., 326), which regulate the amount of exhaust gases expelled from the cylinders (e.g., 324) after combustion.

The combustion cycle of a diesel engine includes what is referred to as the scavenging process. During the scavenging process, a positive pressure gradient is maintained from the intake port of the airbox 308 to the exhaust manifold 312 such that the cooled charge air from the airbox 308 charges the cylinders (e.g., 324) and scavenges most of the combusted gas from the previous combustion cycle. More specifically, during the scavenging process in the power assembly 310, the cooled charge air enters one end of the cylinder (e.g., 324) controlled by an associated piston (e.g., 328) and intake ports. The cooled charge air mixes with the small amount of combusted gas remaining from the previous cycle. At the same time, the larger amount of combusted gas exits the other end of the cylinder (e.g., 324) via four exhaust valves (e.g., 334) and enters the exhaust manifold 312 as exhaust gas. The control of these scavenging and mixing processes is instrumental in emissions reduction as well as in achieving desired levels of fuel economy.

Exhaust gases from the combustion cycle exit the engine 306 via an exhaust manifold 312. The exhaust gas flow from the engine 306 is used to power the turbine 304 of the turbocharger 300, and thereby the compressor 302 of the turbocharger 300. After powering the turbine 304 of the turbocharger 300, the exhaust gases are released into the atmosphere 316 via an exhaust stack 336 or silencer.

Emissions reduction may be achieved by recirculating some of the exhaust gas back through the engine system. Major constituents of exhaust gas that are recirculated include N₂, CO₂, and water vapor, which affect the combustion process through dilution and thermal effects. The dilution effect is caused by the reduction in the concentration of oxygen in intake air, and the thermal effect is caused by increasing the specific heat capacity of the charge.

The exhaust gases released into the atmosphere by a diesel engine include particulates, nitrogen oxides (NOₓ) and other pollutants. Legislation has been passed to reduce the amount of pollutants that may be released into the atmosphere. Traditional systems have been implemented which reduce these pollutants, but at the expense of fuel efficiency. Accordingly, it is an object of the present invention to provide a system which reduces the amount of pollutants released by the diesel engine while achieving desired fuel efficiency.

It is a further object of the present invention to provide an EGR system for a uniflow two-stroke diesel engine, which manages the aforementioned scavenging and mixing processes to reduce NOₓ while achieving desired fuel economy. It is, therefore, an object of the present invention to provide a piston arrangement which may be used with the EGR system. It is desired that the piston arrangement achieves a reduced level of smoke and particulate matter; promotes the mixing process in the engine cylinder; and provides a lower compression ratio for reducing NOₓ emissions.

The various embodiments of the present invention EGR system are able to exceed what is referred in the industry as the Environmental Protection Agency's (EPA) Tier II (40 CFR 92) and Tier III (40 CFR 1033) NOₓ emission requirements, as well as the more stringent European Commission (EURO) Tier IIIb NOₓ emission requirements. These various emission requirements are cited by reference herein and made a part of this patent application.

### SUMMARY OF INVENTION

The present invention generally relates to a diesel engine and, more particularly, to a piston arrangement for a uniflow two-stroke locomotive diesel engine having an EGR system. The piston arrangement has a unique bowl geometry which achieves a reduced level of smoke and particulate matter; promotes the mixing process in the engine cylinder; and provides a lower compression ratio for reducing NOₓ emissions.

Specifically, a piston bowl geometry arrangement is provided for a diesel engine having an exhaust gas recirculation (EGR) system adapted to reduce NOₓ emissions and achieve desired fuel economy by recirculating exhaust gas through the engine. The piston bowl geometry arrangement includes a toroidal major diameter between about 4.795 inches to about 5.045 inches; a toroidal minor radius between about 0.595 inches to about 0.665 inches; a toroidal submersion below the squish land between about 0.787 inches to about 0.867 inches; a center cone angle between about 26 degrees to about 34 degrees; a crown rim radius of about 0.375 inches; a crown thickness between about 0.196 inches to about 0.240 inches; a center spherical radius of about 0.79 inches; a piston diameter of about 8.50 inches; a piston bowl depth between about 1.647 inches to about 1,707 inches; and a squish volume of about 0.305 cubic inches, wherein the piston bowl geometry arrangement promotes mixture of fuel and gas including recirculated exhaust gas in its volume and wherein the squish volume defines an engine compression ratio of about 17:1 to limit maximum firing pressure and lower NOₓ emissions. The squish volume may be defined in part by the piston bowl volume; the size and shape of a cylinder head seat ring; and/or the heads of exhaust valves.

The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiments shown, but is to be accorded the widest scope consistent with the principles and features described herein.

### BRIEF DESCRIPTION OF THE DRAWINGS

FIG. 1 is a perspective view of a locomotive including a two-stroke diesel engine system.

FIG. 2 is a partial cross-sectional perspective view of the two-stroke diesel engine system of FIG. 1.

FIG. 3 is a system diagram of the two-stroke diesel engine of FIG. 2 having a conventional air system.

FIG. 4 is a system diagram of a two-stroke diesel engine having an EGR system.

FIG. 5A is a cross-sectional view of the two-stroke diesel engine of FIG. 4.

FIG. 5B is a schematic, partly cut-away cross-sectional view of the two-stroke internal combustion diesel engine of FIG. 4, showing the exhaust valves.

FIG. 5C is a schematic, partly cut-away cross-sectional view of a two-stroke internal combustion diesel engine of FIG. 4, showing the fuel injector.

FIG. 6A is a partial cross-sectional view of a piston according to the present invention.

FIG. 6B is a cross-sectional view of a cylinder head ring situated in relation to a cylinder head according to the present invention.

FIG. 6C is a top view of a cylinder head ring of FIG. 6B.

FIG, 6D is a partial cross-sectional view of an exhaust valve according to the present invention.

FIG. 6E is a side view of the exhaust valve of FIG. 6D.

FIG. 6F is a bottom view of the exhaust valve of FIG. 6D.

FIG. 7A is a detail, partly cut-away sectional side view of a fuel injector nozzle according to the present invention.

FIG. 7B is a sectional view of a first preferred embodiment of the fuel injector nozzle of FIG. 7A.

FIG. 7C is a sectional view of a second preferred embodiment of the fuel injector nozzle of FIG. 7A.

FIG. 8A is a timing chart for the optimized two-stroke diesel engine, according to the present invention.

FIG. 8B is a graph showing the lift and velocity profiles of the exhaust for the entire engine cycle.

FIG. 8C is a cross-sectional view of an exhaust cam profile according to the present invention.

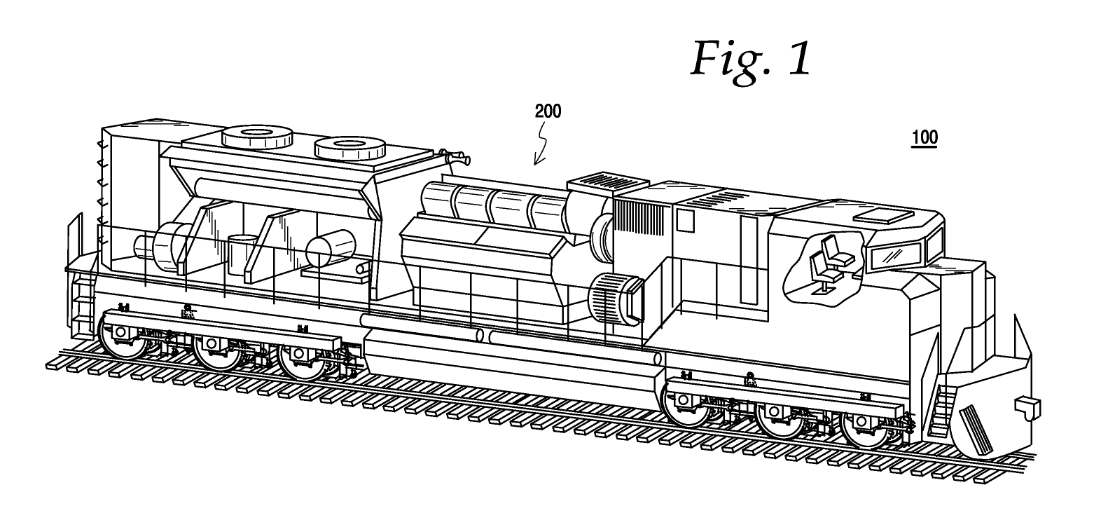

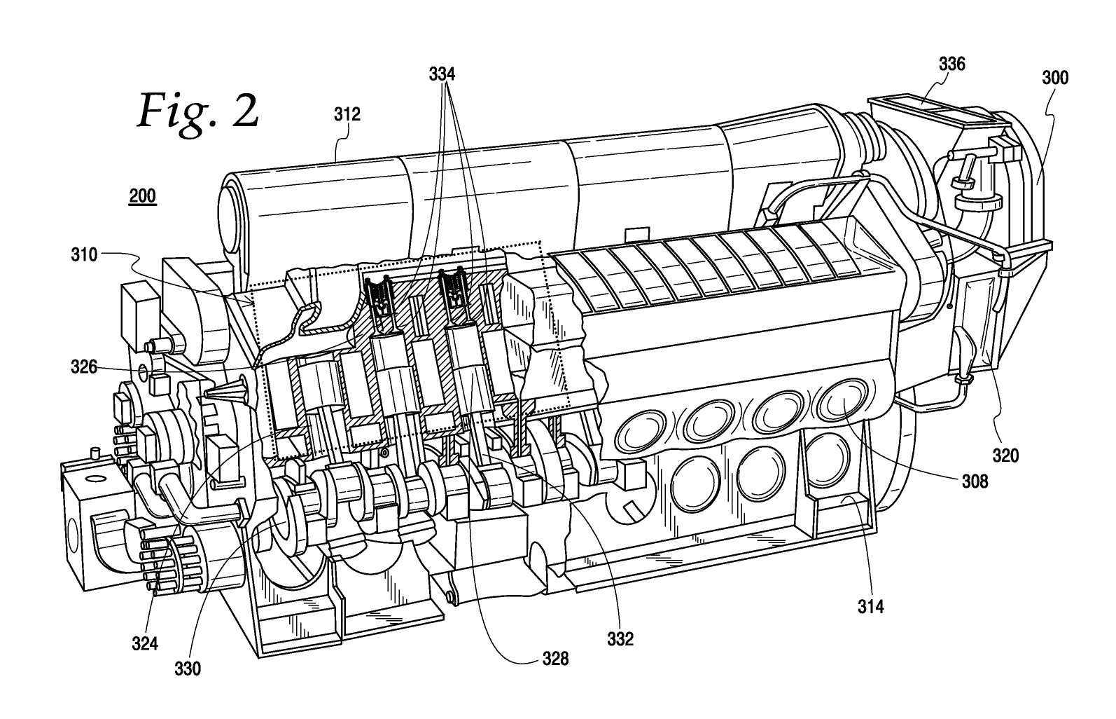

### DETAILED DESCRIPTION OF THE PREFERRED EMBODIMENTS

The present invention is directed to a piston arrangement for a uniflow two-stroke locomotive diesel engine having an EGR system. The piston arrangement has a unique bowl geometry which achieves a reduced level of smoke and particulate matter; promotes the mixing process in the engine cylinder; and provides a lower compression ratio for reducing NOₓ emissions.

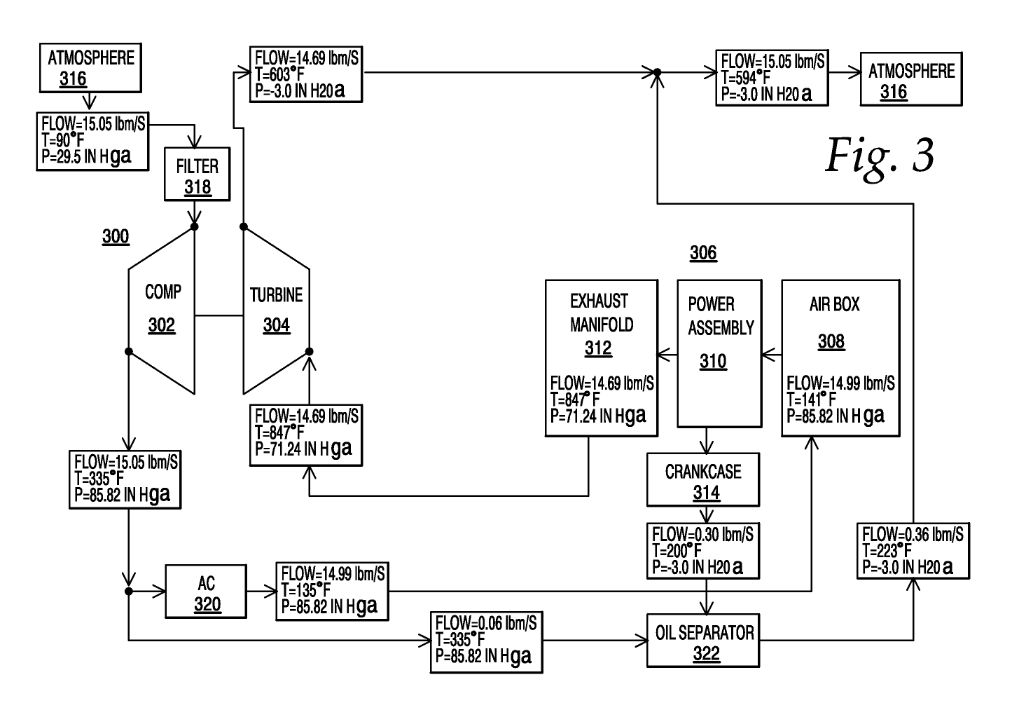

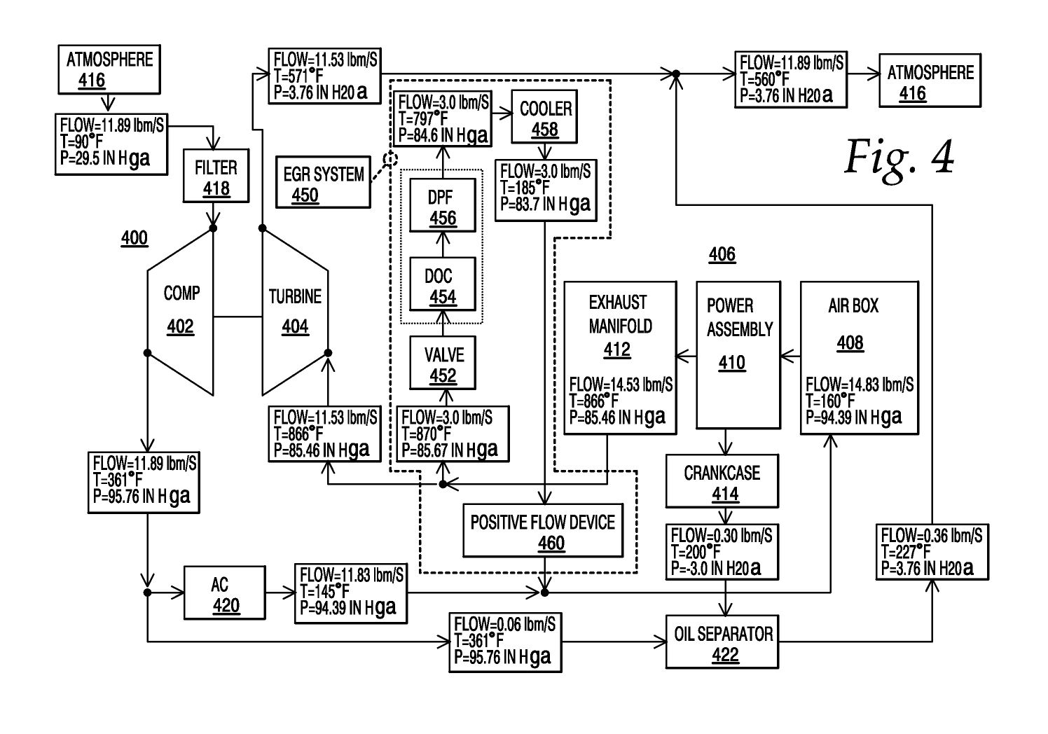

In order to meet at least U.S. EPA Tier III emission standards, as well as the more stringent European Commission Tier IIIb NOₓ emission requirements, several key design changes have been made to the locomotive system of FIG. 3. As shown in FIG. 4, an EGR system 450 is illustrated which recirculates through the engine 406 exhaust gases from the exhaust manifold 412 of the engine 406, mixes the exhaust gases with the cooled charge air of the aftercooler 420, and delivers such to the airbox 408. In this EGR system, only a select percentage of the exhaust gases is recirculated and mixed with the intake charge air in order to selectively reduce pollutant emissions (including NOₓ) while achieving desired fuel efficiency. The percentage of exhaust gases to be recirculated is also dependent on the amount of exhaust gas flow needed for powering the compressor 402 of the turbocharger 400. It is desired that enough exhaust gas powers the turbine 404 of the turbocharger 400 such that an optimal amount of fresh air is transferred to the engine 406 for combustion purposes. For locomotive diesel engine applications, it is desired that less than about 35% of the total gas (including compressed fresh air from the turbocharger and recirculated exhaust gas) delivered to the airbox 408 be recirculated. This arrangement provides for pollutant emissions (including NOₓ) to be reduced, while achieving desired fuel efficiency.

A flow regulating device may be provided for regulating the amount of exhaust gases to be recirculated. In one embodiment, the flow regulating device is a valve 452 as illustrated in FIG. 4. Alternatively, the flow regulating device may be a positive flow device 460, wherein there is no valve (not shown) or the valve 452 may function as an on/off valve as will be discussed in greater detail below.

The select percentage of exhaust gases to be recirculated may be optionally filtered. Filtration is used to reduce the particulates that will be introduced into engine 406 during recirculation. The introduction of particulates into the engine 406 causes accelerated wear especially in uniflow two-stroke diesel engine applications. If the exhaust gases are not filtered and recirculated into the engine, the unfiltered particulates from the combustion cycle would accelerate wear of engine components. For example, uniflow two-stroke diesel engines are especially sensitive to cylinder liner wall scuffing as hard particulates are dragged along the cylinder liner walls by piston rings after passing through the intake ports. Oxidation and filtration may also be used to prevent fouling and wear of other EGR system components (e.g., cooler 458 and positive flow device 460) or engine system components. In FIG. 4, a diesel oxidation catalyst (DOC) 454 and a diesel particulate filter (DPF) 456 are provided for filtration purposes. The DOC 454 uses an oxidation process to reduce the particulate matter (PM), hydrocarbons and/or carbon monoxide emissions in the exhaust gases. The DPF 456 includes a filter to reduce PM and/or soot from the exhaust gases. The DOC/DPF arrangement may be adapted to passively regenerate and oxidize soot. Although a DOC 454 and DPF 456 are shown, other comparable filters may be used.

The filtered exhaust gas is optionally cooled using cooler 458. The cooler 458 serves to decrease the recirculated exhaust gas temperature, thereby providing a denser intake charge to the engine. The decrease in recirculated exhaust gas intake temperature reduces NOₓ emissions and improves fuel economy. It is preferable to have cooled exhaust gas as compared to hotter exhaust gas at this point in the EGR system due to ease of deliverability and compatibility with downstream EGR system and engine components.

The cooled exhaust gas flows to a positive flow device 460 which provides for the necessary pressure increase to overcome the pressure loss within the EGR system 450 itself and overcome the adverse pressure gradient between the exhaust manifold 412 and the introduction location of the recirculated exhaust gas. Specifically, the positive flow device 460 increases the static pressure of the recirculated exhaust gas sufficient to introduce the exhaust gas upstream of the power assembly 410. Alternatively, the positive flow device 460 decreases the static pressure upstream of the power assembly 410 at the introduction location sufficient to force a positive static pressure gradient between the exhaust manifold 412 and the introduction location upstream of the power assembly. The positive flow device 460 may be in the form of a roots blower, a venturi, impeller, propeller, turbocharger, pump or the like. The positive flow device 460 may be internally sealed such that oil does not contaminate the exhaust gas to be recirculated.

As shown in FIG. 4, in one example, there is a positive pressure gradient between the airbox 408 (e.g., about 94.39 inHga) to the exhaust manifold 412 (e.g., about 85.46 inHga) to attain the necessary levels of cylinder scavenging and mixing. In order to recirculate exhaust gas, the recirculated exhaust gas pressure is increased to at least match the aftercooler discharge pressure as well as overcome additional pressure drops through the EGR system 450. Accordingly, the exhaust gas is compressed by the positive flow device 460 and mixed with fresh air from the aftercooler 420 in order to reduce NOₓ emissions while achieving desired fuel economy. It is preferable that the introduction of the exhaust gas is performed in a manner which promotes mixing of recirculated exhaust gas and fresh air.

As an alternative to the valve 452 regulating the amount of exhaust gas to be recirculated as discussed above, a positive flow device 460 may instead be used to regulate the amount of exhaust gas to be recirculated. For example, the positive flow device 460 may be adapted to control the recirculation flow rate of exhaust gas air from the engine 406, through the EGR system 450, and back into the engine 406. In another example, the valve 452 may function as an on/off type valve, wherein the positive flow device 460 regulates the recirculation flow rate by adapting the circulation speed of the device. In this arrangement, by varying the speed of the positive flow device 460, a varying amount of exhaust gas may be recirculated. In yet another example, the positive flow device 460 is a positive displacement pump (e.g., a roots blower) which regulates the recirculation flow rate by adjusting its speed.

A new turbocharger 400 is provided having a higher pressure ratio than that of the prior art uniflow two-stroke diesel engine turbochargers. The new turbocharger provides for a higher compressed charge of fresh air, which is mixed with the recirculated exhaust gas from the positive flow device 460. This high pressure mixture of fresh air and exhaust gas delivered to the engine 406 provides the desired trapped mass of oxygen necessary for combustion given the low oxygen concentration of the trapped mixture of fresh air and cooled exhaust gas.

The EGR system 450 of FIG. 4 is shown for illustrative purposes only. Other comparable EGR systems may be similarly implemented in order to recirculate exhaust gas in the engine for the purposes of reducing NOₓ emissions. For example, recirculated exhaust gas may be alternatively introduced upstream of the aftercooler and cooled thereby before being directed to the airbox of the engine. In another embodiment, the filtered exhaust gas may optionally be directed to the aftercooler without the addition of the cooler in the EGR system. In yet another embodiment, a control system may further be provided which controls the select components of the EGR system. In one example, a control system controls the flow regulating device to adaptively regulate the amount of exhaust gas being recirculated based on various operating conditions of the locomotive.

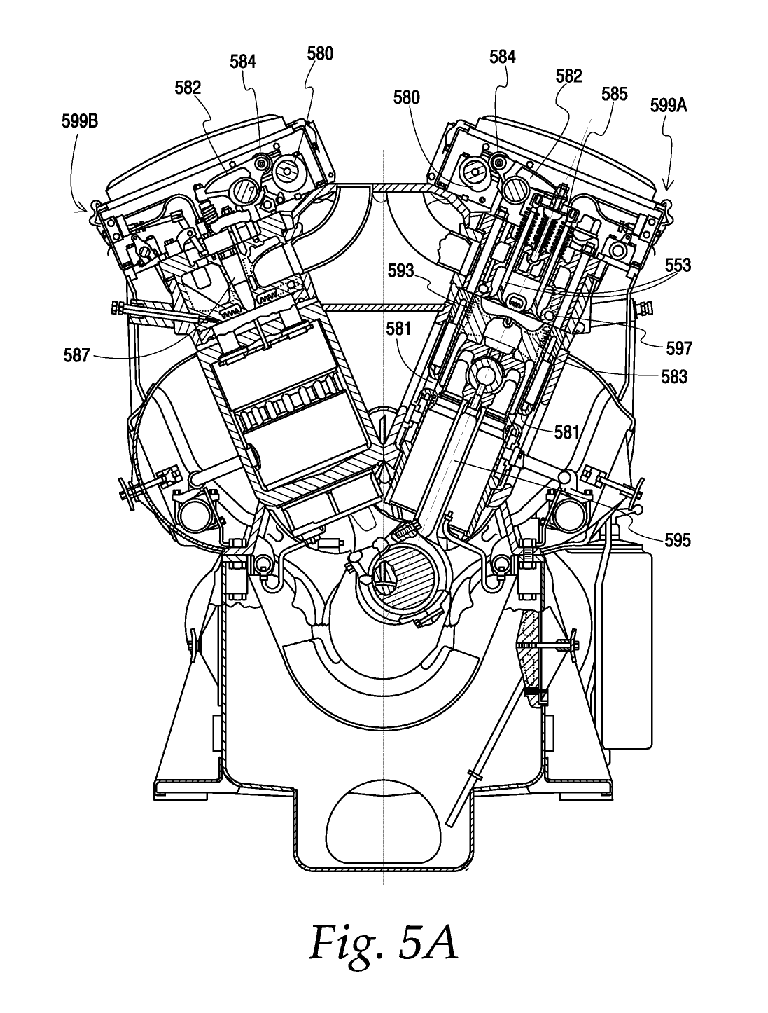

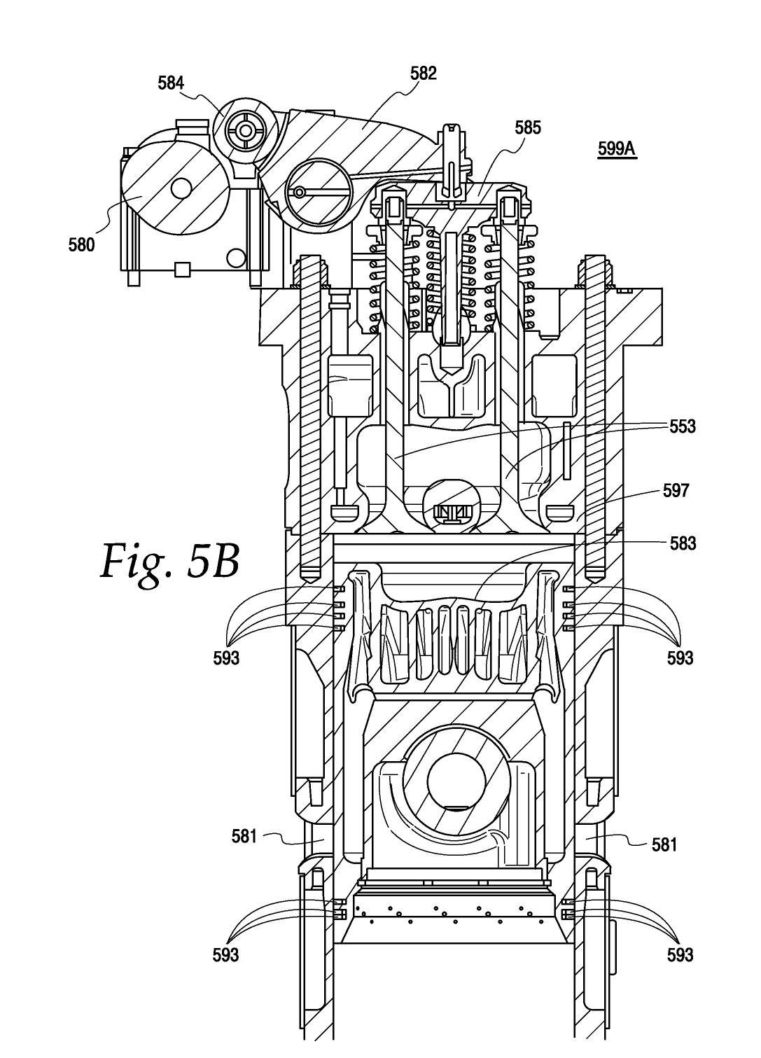

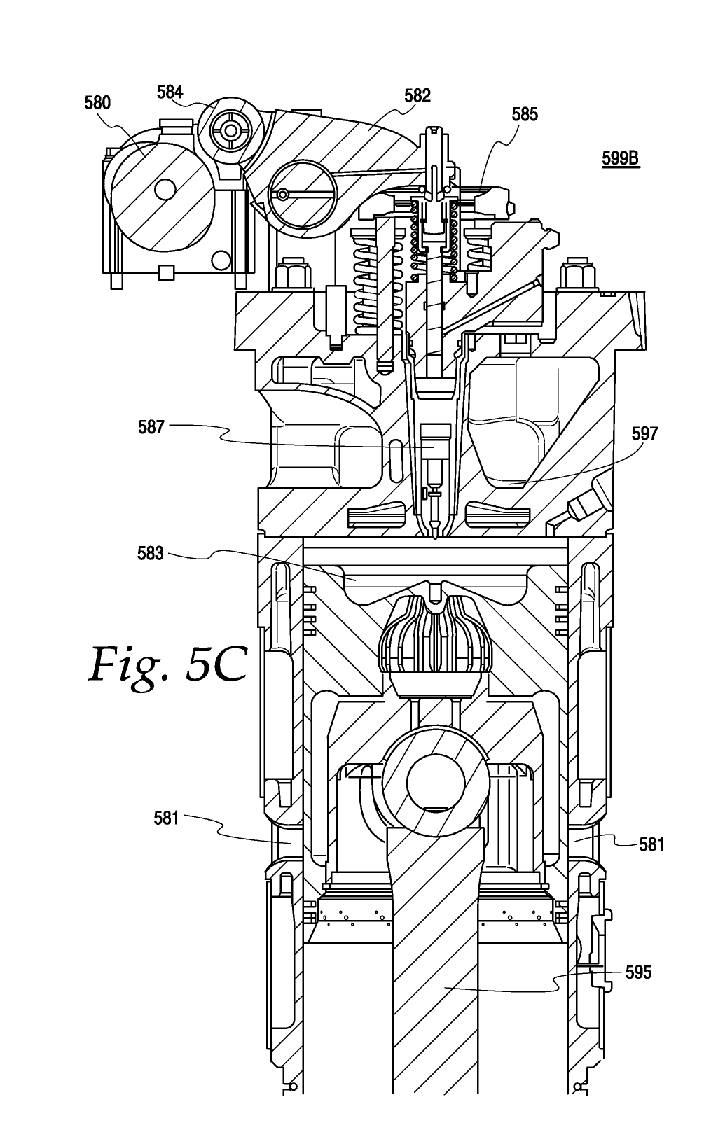

In order to further optimize the EGR system 450 illustrated in FIG. 4, several engine components have been redesigned, resulting in increased fuel efficiency and reduced NOₓ emissions. Specifically, the present invention engine includes: (1) a new piston arrangement with a unique bowl geometry; (2) an optimized fuel injector system; and (3) a new exhaust cam. FIGS. 5A-5C are various cross-sectional views of a uniflow two-stroke diesel engine being redesigned for use with the EGR system 450 of FIG. 4.

The first new engine component redesigned for use with the EGR system is the piston arrangement. As illustrated in FIGS. 5A-5C, a piston 583 is carried by a piston carrier. The piston includes a generally annular sidewall having a plurality of grooves thereon. The grooves 593 receive a plurality of rings to seal the piston 583 against the sidewall of the cylinder liner, as is well known in the art. A connecting rod 595 may also be pivotally secured to the piston in a conventional manner.

A new piston bowl geometry when paired with the fuel injection system described below promotes the mixture of fuel and the trapped gas (including intake charge air and recirculated exhaust gas) in the cylinder. Furthermore, the piston bowl helps to reduce the amount of smoke and particulate matter by its new unique geometry. The piston bowl volume, cylinder, cylinder head and exhaust valves define the volume at piston top dead center (TDC), being preferably equal to about 0.3053 cubic inches, thereby defining the compression ratio which is about 17:1. The lower compression ratio offsets the higher airbox pressure, thereby limiting maximum firing pressure and lowering NOₓ.

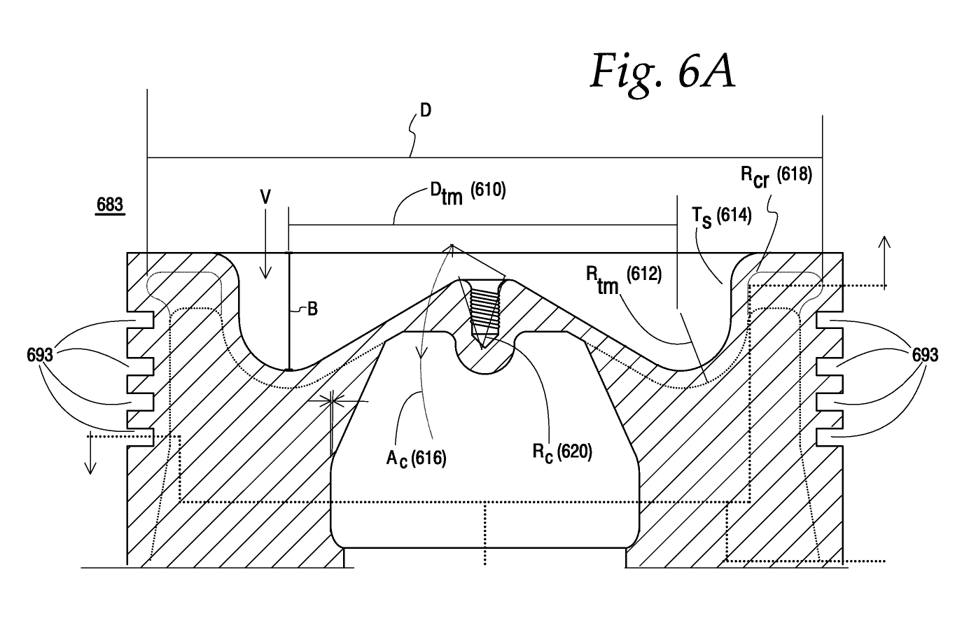

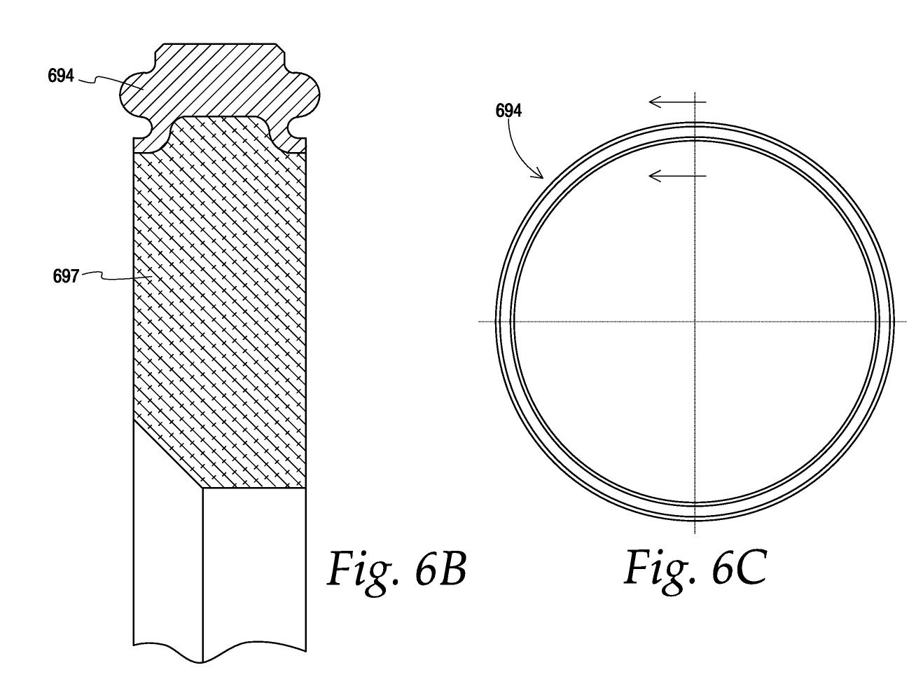

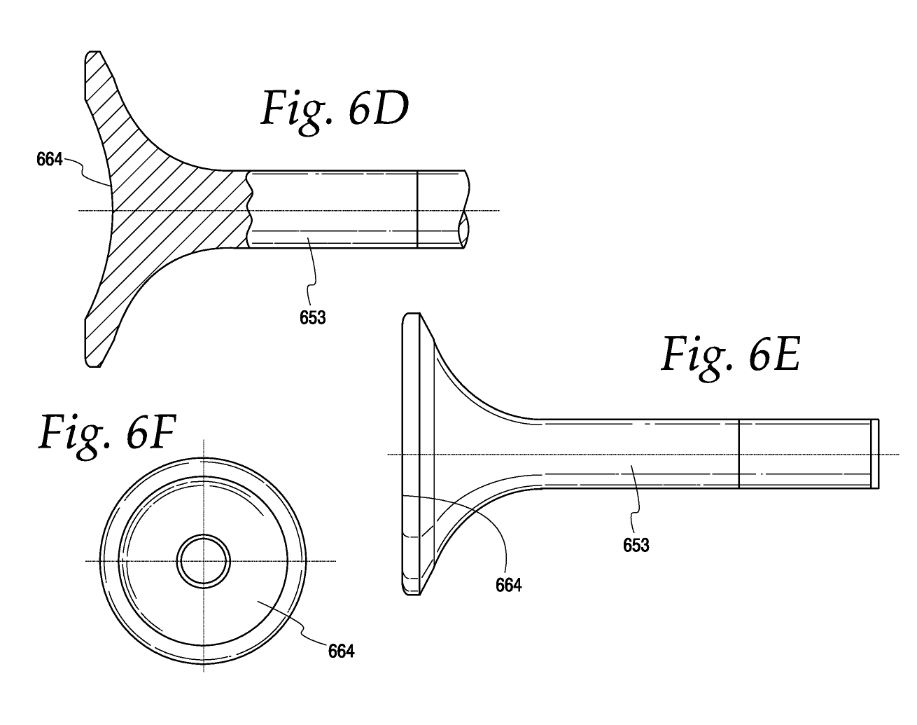

Specifically, as illustrated in FIG. 6a, the piston bowl 683 includes a center portion having a generally spherical shape. Preferably, the center portion has a center spherical radius R_{c} (620) preferably equal to about 0.79 inches. A cone portion is connected to the center portion and preferably is formed at an angle (center cone angle A_{c} (616)) preferably equal to 30 degrees plus or minus 4 degrees. An annular toroidal surface is formed adjacent to the cone portion and is defined in part by a toroidal major diameter Dₜₘ (610) preferably equal to 4.92 inches, plus or minus 0.125 inches, and a toroidal minor radius Rₜₘ (612) preferably equal to 0.63 inches, plus or minus 0.035 inches. A crown rim is formed adjacent to the annular toroidal surface and is connected to an upper flat rim face of a sidewall. The crown rim radius R_{cr} (618) is preferably equal to about 0.375 inches.

The annular toroidal surface is preferably formed wherein the toroidal minor radius Rₜₘ (612) is measured from a point that is submerged 0.827 inches, plus or minus 0.04 inches, below the upper flat rim face. This is also known as the toroidal submersion below squish land and is denoted as Tₛ (614) in FIG. 6a.

Thus, the new piston bowl 683 design includes the following: a toroidal major diameter Dₜₘ (610) preferably equal to 4.92 inches, plus or minus 0.125 inches; a toroidal minor radius Rₜₘ (612) preferably equal to 0.63 inches, plus or minus 0.035 inches; a toroidal submersion Tₛ (614) below the squish land preferably equal to 0.827 inches, plus or minus 0.04 inches; a squish area preferably about 2.827 square inches; a squish height preferably about 0.088 inches; a piston bowl volume preferably equal to 0.249 cubic inches; a center cone angle A_{c} (616) preferably equal to 30 degrees plus or minus 4 degrees; a crown rim radius R_{CR} (618) preferably equal to 0.375 inches; a crown thickness preferably between about 0.196 inches and about 0.240 inches; a center spherical radius R_{c} (620) preferably equal to 0.79 inches; a piston diameter D preferably equal to 8.50 inches; and a piston bowl depth B preferably equal to 1.677 inches, plus or minus 0.03 inches. Accordingly, the ratio of the toroidal major diameter Dₜₘ (610) relative to the piston diameter D is 1:1.73; the ratio of the toroidal minor radius Rₜₘ (612) relative to the piston diameter D is 1:13.49; and the ratio of piston bowl depth B to the piston diameter D is 1:5.07.

The piston arrangement also has a squish volume preferably equal to about 0.305 cubic inches. This increased volume, from that of prior art, lowers the engine compression ratio from about 18.4:1 to about 17:1. The lower compression ratio offsets the higher airbox pressure, thereby limiting maximum firing pressure and lowering NOₓ. The piston bowl volume, cylinder, cylinder head and exhaust valves define the squish volume at TDC. Accordingly, the desired squish volume may be achieved by adjusting any one of the piston bowl 683 volume of FIG. 6a, the size of the cylinder head seat ring 694 as shown in FIGS. 6b-6c, and/or the size of the cupped heads 664 of exhaust valves 653 as shown in FIGS. 6d-6f, alone or in combination. In one example, the piston bowl depth B may be increased or decreased by adjusting the depth of the sidewall of the piston bowl in order to adjust the piston bowl volume. In another example, as shown in FIGS. 6b-6c, a cylinder head seat ring 694 may be placed on the cylinder head 697 to prevent the piston from abutting the surface of the cylinder head 697. Adjusting the size of the cylinder head ring results in adjustment of the squish volume. In yet another example, as shown in FIGS. 6d-6f, the volume of the cupped heads 664 of the exhaust valves 653 may be adjusted in order to increase or decrease squish volume.

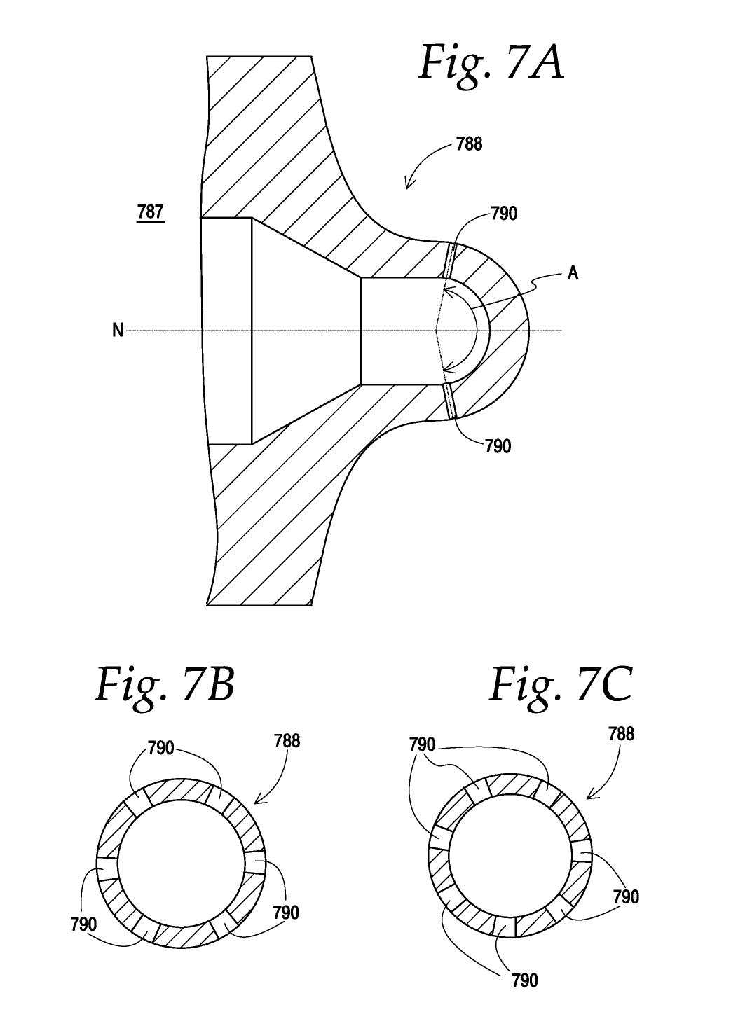

The redesigned piston arrangement is paired with a fuel injector system as shown at 587 in FIGS. 5A and 5C. As further detailed in FIGS. 7A-7C, the fuel injector 787 has a fuel injector nozzle body 788 having six or seven, fuel injection holes 790. The fuel injection holes 790 are of mutually equal size and are equidistantly spaced concentrically around a nozzle centerline N. Each of the fuel injector holes 790 is provided with a reduced diameter hole size, the hole diameter being within the range of between preferably 0.0133 inches and 0.0152 inches. The included Angle A of the fuel injection holes is preferably 150 degrees, plus or minus 4 degrees. The reduced diameter hole size provides reduction in the fuel injection rate along with an increase in fuel injection duration and a rise in peak fuel injection pressure, and serves to lower the NOₓ formation during the fuel combustion process, as it sprays fuel onto the new piston bowl geometry to lower smoke and particulate levels.

The next new engine component redesigned for use with the EGR system is a new engine exhaust valve timing and lift system. Specifically, FIGS. 5A-5C illustrate the two cylinder banks 599A, 599B of the engine, each having a plurality of cylinders closed by cylinder heads 597. The cylinder heads 597 contain exhaust ports that communicate with the combustion chambers and are controlled by exhaust valves 553 mounted in the cylinder heads 597. In this system, the exhaust valves 553 regulate the amount of exhaust gases expelled from the combustion chamber. The timing, lift and velocity of exhaust valve opening and closing are controlled in order to attain the desired NOₓ emission levels and the desired levels of cylinder scavenging and mixing.

As illustrated in FIGS. 5A and 5B, the exhaust valves 553 are mechanically actuated by an exhaust cam 580 of a camshaft driving an associated valve actuating mechanism, such as a rocker arm 582. Specifically, FIG. 5A illustrates a cross-sectional view of the two-stroke diesel engine, showing two exhaust valves 553 being actuated by an exhaust cam 580. The exhaust cam 580 generally includes a select shape which determines the lift, timing and velocity of exhaust valve actuation. In order to open the exhaust valves 553, the exhaust cam 580 lobe engages a roller 584 located on a rocker arm 582, Once the cam lobe engages the rocker arm 582 via the roller 584, the rocker arm 582 engages a valve bridge 585, which causes compression in adjacent springs and causes the exhaust valves 553 to open. The exhaust cam 580 controls the timing, lift and velocity of exhaust valve opening and closing in order to attain the desired NOₓ emission levels and the desired levels of cylinder scavenging and mixing.

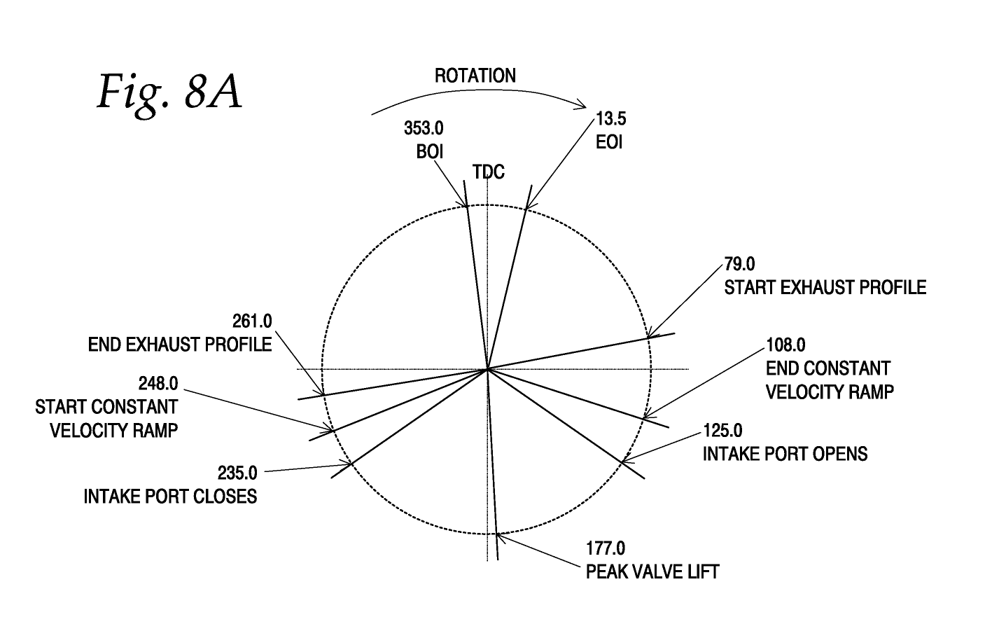

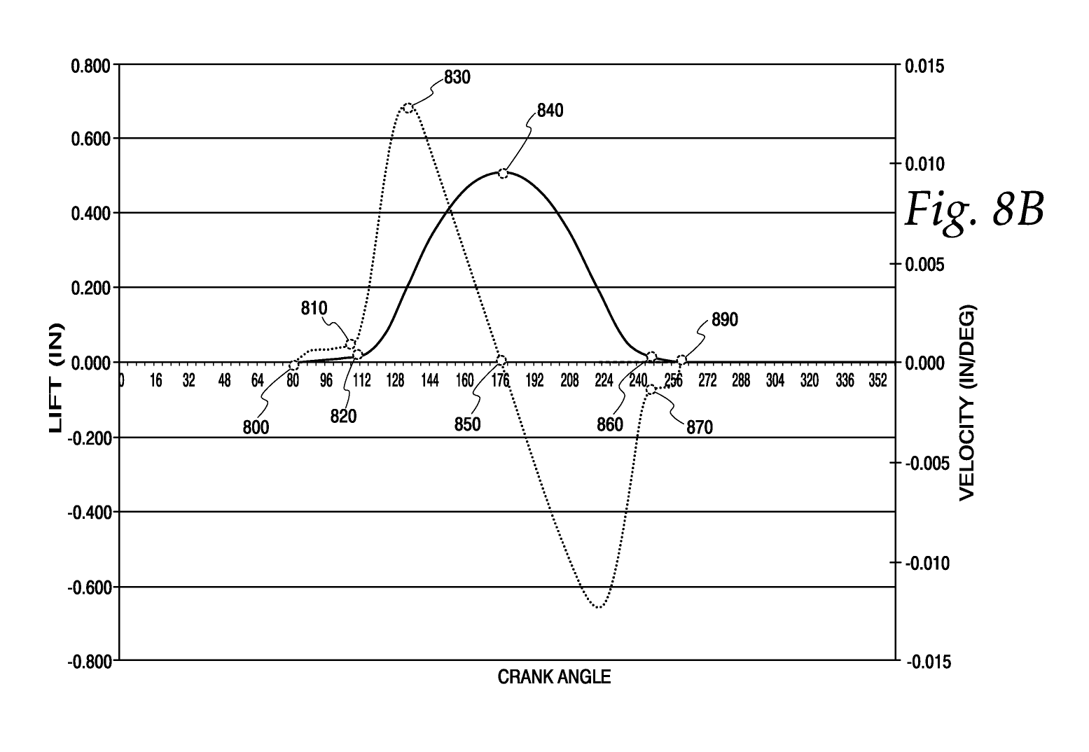

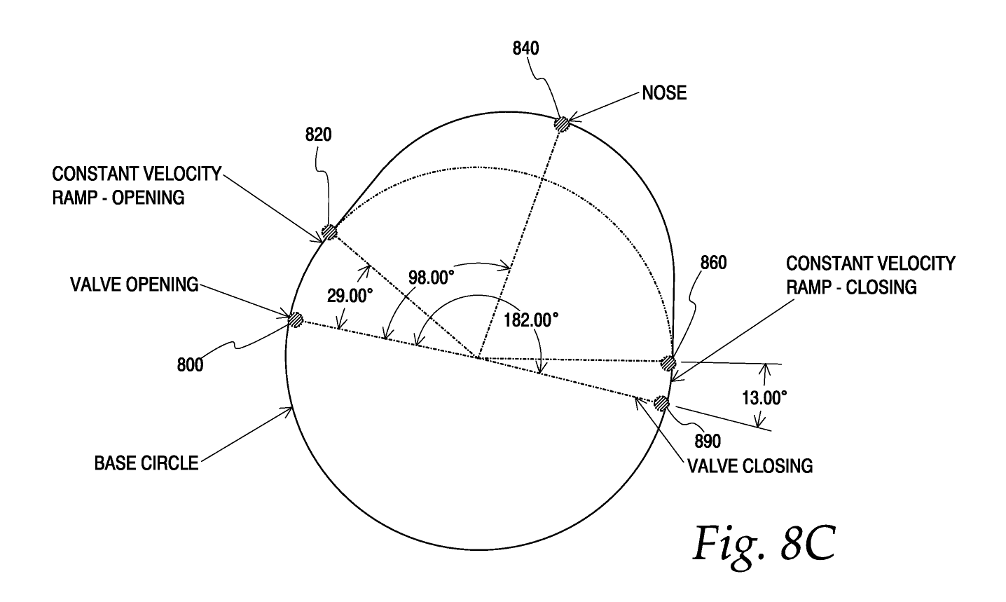

The operation of the engine components redesigned for use with the EGR described above is detailed in the engine timing chart of FIG. 8A. Specifically, the engine timing chart illustrates the effects of the redesigned engine components on the EGR system. As shown, combustion occurs at or near piston TDC Fuel injection into the cylinder begins near TDC and ends after TDC, with specific timing being dependent on the locomotive operating conditions. For example, at full load, the fuel injection timing starts at about 7 degrees before TDC and ends at about 13 degrees after TDC. Expansion of the cylinder gas generally begins at TDC and continues until exhaust valves open, The exhaust valves open at about 79 degrees past TDC. Until about 108 degrees past TDC, the exhaust valves open at a slow constant velocity as will be described in further detail with regards to FIG. 8B. Between about 108 degrees and 125 degrees past TDC, exhaust gas exits the cylinder as the cylinder pressure is higher than the exhaust pressure. The intake ports open at about 125 degrees past TDC at which point cylinder pressure is generally higher than airbox pressure. The cylinder pressure causes most of the exhaust gas to flow through the exhaust valves while some exhaust gas may flow into the airbox. When cylinder pressure reaches airbox pressure, a positive pressure gradient from the intake ports to the exhaust valves then charges the cylinder with cooled charge air (and recirculated exhaust gas) from the airbox and scavenges most of the exhaust gas from the previous cycle. The cooled charge air (and recirculated exhaust gas) mixes with the small amount of exhaust gas remaining from the previous cycle. The peak valve lift during the scavenging process occurs near bottom dead center at about 177 degrees past TDC, where compression begins. Cooled charge air (and recirculated exhaust gas) continues to enter the cylinder until the intake ports close at about 235 degrees past TDC. Exhaust gas and cooled charged air (and recirculated exhaust gas) are compressed and scavenging continues until about 261 degrees after TDC when exhaust valves close. It is important to note that the exhaust valves are nearly closed at about 248 degrees past TDC. Cylinder compression continues until TDC, near which the combustion cycle begins once again.

The geometry of the new piston bowl (shown in FIG. 6) and intake port promotes the mixture of fuel and the trapped gas (including cooled charge air and recirculated exhaust gas) in the cylinder. The piston bowl volume, cylinder, cylinder head and exhaust valves define the volume at TDC, thereby defining the compression ratio range of about 16.7:1 to 17.5:1. As discussed above, the lower compression ratio offsets the higher airbox pressure, thereby limiting maximum firing pressure and lowering NOₓ.

As discussed above, the valves are mechanically actuated by exhaust cams of a camshaft. Because the timing and lift of all exhaust valve events are determined by the cam, a new cam lobe arrangement for exhaust valves is provided to achieve external EGR in accordance with the new EGR system. The timing and lift of valve actuation, in part, depends on what portion of the cam (i.e. cam angle) is engaging the roller at a given point in time. The timing and lift of valve opening and closing is important to attain the desired NOₓ emission levels and the desired levels of cylinder scavenging and mixing. The exhaust profile of the cam has a peak roller lift when the cam rotates to about 177 degrees after TDC, as illustrated in FIGS. 8A-8C. The valve closes as the cam rotates to about 261 degrees after TDC. Because the exhaust valve remains open for a longer period of time, as compared to the system of FIG. 3, it provides for a longer period for cylinder scavenging.

Specifically, FIGS. 8B and 8C further illustrate the correlation between cam angle and exhaust valve lift. Moreover, because of the select shape of the cam, the steepness of the cam corresponds to the velocity of valve opening and closing. As shown in FIG. 8C, the cam generally includes a base circle and a cam profile lobe. When the base circle engages the rocker arm roller, the valve is closed. Once the cam rotates such that the cam profile lobe, and specifically the ramp portion of the lobe, engages the roller, the exhaust valve begins to lift. Although the base circle is circular, the lobe is oblong. Therefore, as the angle and steepness of the portion of the cam engaging the rocker arm changes, the velocity of valve opening changes accordingly.

Now referring to both FIGS. 8B and 8C, the exhaust valve begins to open when the cam rotates to an angle of 79 degrees (shown at 800). The valve opens at a low constant velocity (shown between 800 and 810) for about 29 degrees, until the cam rotates to 108 degrees (shown at 810). Maintaining a low constant velocity during valve opening and closing is an important factor in avoiding mechanical failure of the valve system. When the valves open and close at high velocities, the valves and other system components are subjected to high impact loads, which frequently result in mechanical valve system failure. Accordingly, the opening and closing ramps are designed such that the valve seating and valve unseating velocities are low. The lower the opening and/or closing velocity, the lower the valve seating and valve unseating loads are exerted on the valve train system.

The low constant velocity ends when the cam rotates to about 108 degrees, at which point the steep portion (or flank) of the cam lobe engages and lifts the roller. As the cam rotates from a crank angle of about 108 degrees to about 138 degrees, valve opening velocity sharply increases (shown between 810 and 830 in FIG. 8B) over 10 fold. As the roller approaches the nose of the cam, the valve opening velocity decreases. When the cam reaches a rotation of about 177 degrees (shown at 840), it causes the roller to reach its peak lift, which corresponds to the peak valve lift. When the valve is at its peak lift (at 840), the nose of the cam lobe is engaging the roller and valve velocity returns to 0 in/degrees (shown at 850). As the cam continues to rotate, the valve begins to close initially at a higher velocity until it reaches about 248 degrees. The valve is almost closed when the cam rotates to an angle of about 248 degrees (shown at 860), at which point the valve closing velocity slows to constant velocity (shown at 870). This low constant velocity is maintained for approximately 13 degrees until the cam rotates to an angle of about 261 degrees, at which point the valve is fully closed (shown at 890).

The various embodiments of the present invention may be applied to both low and high pressure loop EGR systems. The various embodiments of the present invention may be applied to locomotive two-stroke diesel engines may be applied to engines having various numbers of cylinders (e.g., 8 cylinders, 12 cylinders, 16 cylinders, 18 cylinders, 20 cylinders, etc.). The various embodiments may further be applied to other two-stroke uniflow scavenged diesel engine applications other than for locomotive applications (e.g., marine applications).

As discussed above, NOₓ reduction is accomplished through the EGR system while the new engine components maintain the desired levels of cylinder scavenging and mixing in a uniflow scavenged two-stroke diesel engine. Embodiments of the present invention relate to a locomotive diesel engine and, more particularly, to a piston arrangement for a two-stroke locomotive diesel engine having an exhaust gas recirculation system. The above description is presented to enable one of ordinary skill in the art to make and use the invention and is provided in the context of a patent application and its requirements. Modifications to the various embodiments and the generic principles and features described herein will be readily apparent to those skilled in the art. The present invention is not intended to be limited to the embodiments shown, but is to be accorded the broadest scope consistent with the principles and features described herein.

What is claimed is:

1. A piston bowl arrangement for a diesel engine having an exhaust gas recirculation (EGR) system adapted to reduce NOₓ emissions and achieve desired fuel economy by recirculating exhaust gas through the engine, said piston bowl arrangement including:
a toroidal major diameter between about 4.795 inches to about 5.045 inches;
a toroidal minor radius between about 0.595 inches to about 0.665 inches;
a toroidal submersion below the squish land between about 0.787 inches to about 0.867 inches;
a center cone angle between about 26 degrees to about 34 degrees;
a crown rim radius of about 0.375 inches;
a crown thickness between about 0.196 inches to about 0.240 inches;
a center spherical radius of about 0.79 inches;
a piston diameter of about 8.50 inches;
a piston bowl depth between about 1.647 inches to about 1.707 inches; and
a squish volume of about 0.305 cubic inches, wherein the piston bowl geometry promotes mixture of fuel and gas including recirculated exhaust gas in its volume and wherein the squish volume defines an engine compression ratio of about 17:1 to limit maximum firing pressure and lower NOₓ emissions.

2. The piston bowl arrangement of claim 1 wherein the volume of the piston bowl defines in part the squish volume.

3. The piston bowl arrangement of claim 1, wherein the engine further includes at least one exhaust valve including a cupped head situated in relation to the piston bowl, wherein the volume of the cupped head of the exhaust valve defines in part the squish volume.

4. The piston bowl arrangement of claim 1, wherein the engine further includes at least cylinder head seat ring situated in relation to the piston bowl, wherein the size and shape of the cylinder head seat ring define in part the squish volume.

5. The piston bowl arrangement of claim 1 further including a squish area of about 2.827 square inches.

6. The piston bowl arrangement of claim 1 further including a squish height of about 0.108 inches.

7. The piston bowl arrangement of claim 1 wherein the toroidal major diameter is about 4.92 inches.

8. The piston bowl arrangement of claim 1 wherein the toroidal minor radius is about 0.63 inches.

9. The piston bowl arrangement of claim 1 wherein the toroidal submersion below the squish land is about 0.827 inches.

10. The piston bowl arrangement of claim 1 wherein the center cone angle is about 30 degrees.

11. The piston bowl arrangement of claim 1 wherein the piston bowl depth is about 1.677 inches.
